(19) United States
(12) Patent Application Publication
(10) Pub. No.: US 2025/0156166 A1
(43) Pub. Date: May 15, 2025

(54) Method, Device and Computer Program Product for Producing a User-Specific Functionality of a Vehicle

(71) Applicant: Bayersche Motoren Werke Aktiengesellschaft, Muenchen (DE)

(72) Inventor: Alexander AUGST, Muenchen (DE)

(21) Appl. No.: 18/911,324

(22) Filed: Oct. 10, 2024

(30) Foreign Application Priority Data
Nov. 9, 2023 (DE) 10 2023 131 071.2

(51) Int. Cl. G06F 8/61; G06F 8/35; G06F 9/455; G06F 21/53

(52) U.S. Cl. CPC G06F 8/61; G06F 8/35; G06F 9/45533; G06F 21/53

(57) ABSTRACT

In a method for producing a user-specific functionality of a vehicle, a user input which characterizes the user-specific functionality is detected. Input data are produced depending on the user input. Depending on the input data, at least one part of a program code of a computer program is generated, which computer program provides the user-specific functionality when the computer program is executed on a control unit of the vehicle. The computer program is provided for execution on a control unit of the vehicle in order to provide the user-specific functionality.

### CROSS REFERENCE TO RELATED APPLICATION

This application claims priority under 35 U.S.C. § 119 from German Patent Application No. DE 10 2023 131 071.2, filed Nov. 9, 2023, the entire disclosure of which is herein expressly incorporated by reference.

### BACKGROUND AND SUMMARY

The invention relates to a method for producing a user-specific functionality of a vehicle. The invention furthermore relates to a device and also a computer program product for producing a user-specific functionality of a vehicle.

The prior art discloses various methods in which parts of an application, for example a user interface, are produced with the aid of machine learning methods. Machine learning methods and corresponding developer tools which assist a user in creating an application are furthermore known.

It is an object of the invention to provide a method and a device which enable a user-specific functionality of a vehicle to be produced in a simple manner.

The object is achieved by each of the independent claims. Advantageous embodiments are described inter alia in the dependent claims. It is pointed out that additional features of a patent claim dependent on an independent patent claim, without the features of the independent patent claim or in combination only with a subset of the features of the independent patent claim, may form a standalone invention that is independent of the combination of all of the features of the independent patent claim and may be made into the subject matter of an independent claim, a divisional application or a subsequent application. This applies in the same way to technical teachings that are described in the description and may form an invention independent of the features of the independent patent claims.

In the proposed method for producing a user-specific functionality of a vehicle, a user input which characterizes the user-specific functionality, for example by desired features, is detected. Input data are produced depending on the user input. Depending on the input data, at least one part of a program code of a computer program is generated, which computer program provides the user-specific functionality when the computer program is executed on a control unit of the vehicle. The computer program is provided for execution on a control unit of the vehicle in order to provide the user-specific functionality. Preferably, the proposed method comprises a step in which the computer program is executed on the control unit of the vehicle in order to provide the user-specific functionality.

In particular, the user-specific functionality of the vehicle as described in the present document is a functionality of the vehicle which is specific, in particular individual, to one or more specific users, in particular also to be interpreted as functionality for a vehicle, in particular for the specific vehicle or the specific vehicle functionality. The user is in particular an end customer or end consumer and/or an owner or user of the vehicle. In this case, the invention affords the possibility, even for laypersons, of producing the user-specific functionality adapted to personal wishes or matched or tailored to personal wishes.

The user-specific functionality can comprise or be a new functionality or a functional extension to a vehicle functionality, for example already present in the vehicle and/or provided by a manufacturer, and/or a functional extension to a user-specific functionality already produced.

The program code or the computer program is in particular:
a computer program specialized in embedded and/or automotive systems, in particular in features of a vehicle type, of the control units thereof or further features of the vehicle type;
a nontrivial computer program comprising at least 10, 20, 30, 50, 100, 200 lines of code or a computer program having a comparable complexity, for example in relation to the corresponding source code and/or an executable; and/or
a pointer, for example pointers typical of vehicle bus systems, a computer program comprising access methods and/or interfaces.

The user input can take place in particular in natural language, for example in text form or as a voice input. The program code can be produced in particular on the control unit or one or more further control units of the vehicle itself. By way of example, the program code can be produced on a control unit of the vehicle that is configured for this, the program code or the user-specific functionality being executable on one or more other control units of the vehicle. Alternatively, at least one part of the program code can be produced by a control unit (backend) remote from the vehicle. The user-specific functionality is in particular a functionality of the vehicle which can be executed by one or more functional units of the vehicle. In other words, the user-specific functionality can be regarded as an application which is executable on one or more control units of the vehicle in order to operate one or more functional units of the vehicle.

The term “operating” a vehicle functionality can comprise or be actuating, setting, for example changing an operating mode and/or settings, pausing, deactivating or suspending, in particular momentarily suspending, or adapting an action otherwise due, an initiation or a reaction of the vehicle function. The term “vehicle functionality” can encompass one or more performance features, in particular features, of one or more vehicle functionalities or of a combination thereof.

As an alternative or in addition to a wholly or predominantly independent application, the user-specific functionality can also be produced as an extension of an already existing application, for example of an already existing or already produced vehicle functionality, in particular as a plug-in, in particular a user-specific plug-in. In particular, the user-specific functionality can comprise or be at least one partly autonomous functionality or application integrated or embedded, in particular embedded, at least partly in a corresponding control unit and/or in one or more other vehicle functionalities or in the vehicle.

The control unit of the vehicle as described in the present document can comprise or be for example a computing unit installed in the vehicle or arranged in the vehicle, for example a computing unit, in particular an integration controller, or a computing unit arranged remote from the vehicle, for example a backend or cloud. The control unit of the vehicle can also be formed by both local and remote computing units, for example by means of an information technology operative connection.

With the user input, the user characterizes or else defines the user-specific functionality desired by the user. The user input can comprise for example one or more desired features of a substantially new functionality or features comprising a desired change in a functionality of a vehicle functionality already present in the vehicle, for example.

By way of example, the device, in particular in the context of the generative pretrained transformer described in the present document, can be designed to evaluate a user input which is comparatively abstract and/or is described by a specific relationship and/or logic and/or comprises one or more collective terms.

Alternatively or additionally, the user input can comprise one or more desired operative connections and/or undesired operative connections, in particular to be excluded, between vehicle functionalities and further conditions, databases, data of specific kinds and/or functionalities of the vehicle. By way of example, the user, with their input, establishes an operative connection that the user wants between already existing vehicle functionalities and/or between at least two further vehicle functionalities. One of the at least two functionalities can comprise or be a general vehicle functionality, for example supplied by a manufacturer of the vehicle or by a third party. One of the at least two functionalities can comprise or be a, for example already produced, user-specific functionality. Moreover, the device can take account of an operative connection between at least two user-specific functionalities. In particular, a further user-specific functionality can be produced in this case.

Alternatively or additionally, the user input can define one or more triggers (for example event and/or specific measures of a specific parameter being exceeded or undershot) which are desired and/or undesired, in particular to be excluded, and whose occurrence (for example in the case of their recognition) is intended to operate, in particular trigger, the user-specific vehicle functionality. By way of example, the user, with their user input, can furthermore define triggers whose occurrence triggers the user-specific functionality, for example a specific event and/or a specific variable being exceeded or undershot. Furthermore, it is possible to characterize a logic between at least two triggers. By way of example, if a first trigger occurs twice or three times for example within a journey or a journey identified by specific features and/or no second trigger occurs, then a triggering or non-triggering of a vehicle functionality as characterized for example in the user input ought to take place.

The user input can preferably take place in text form and/or spoken form, in particular in natural language. Therefore, in particular no programming knowledge is required on the part of the user. Furthermore, the user also does not need to have knowledge about the exact modes of operation of the already existing vehicle functionalities in order to be able to define the user-specific functionality. The proposed method thus enables the user to produce the user-specific functionality of the vehicle in a simple manner.

In one embodiment, the program code is produced using a generative pretrained transformer. Generative pretrained transformers are also called GPTs. Generative pretrained transformers, in particular large language models, can interpret natural language and implement instructions produced in natural language. The user input can thus be effected in a manner that is particularly intuitive to the user, as a result of which the production of the user-specific functionality is simplified again. As an alternative to a generative pretrained transformer, it is also possible to use a neural network with a corresponding architecture for the production of the program code.

In particular, the generative pretrained transformer is a generative model, in particular statistical model, in particular a model which is configured for use in a vehicle and/or for producing the user-specific functionality, in particular is specialized—more or less narrowly—therein. In particular, the generative pretrained transformer can comprise a large language model and/or interpret natural language and implement instructions produced in natural language.

Furthermore, the generative pretrained transformer or the model can be a model retrained on a specific vehicle type, the vehicle, a specific user and/or operator of the vehicle, or can be constructed as a model retrained on the basis thereof and/or can be controlled thereby. In particular, the model can comprise or be a language model or a model with language support, in particular a so-called large language model.

In a further embodiment, taking account of at least one driving situation, a state of a vehicle occupant and/or a state of the vehicle and using the generative pretrained transformer, an output is produced in order to assist the user in producing the user input. The output can take place for example in text form and/or as a voice output produced by the generative pretrained transformer.

Preferably, the output is output by an output unit of the vehicle, for example in a graphical and/or auditory form, for example by means of a display unit and/or loudspeaker belonging to the vehicle or carried along in the vehicle. Alternatively or additionally, the output can be output by a mobile terminal of the user, for example a smartphone or a tablet computer. In this embodiment, on the basis of the driving situation, the state of a vehicle occupant and/or the vehicle, the generative pretrained transformer produces for example a list with possible triggers and existing vehicle functionalities which the user can take as a basis for defining the user-specific functionality.

In a further exemplary embodiment, the generative pretrained transformer can be configured, i.e. for example trained and/or retrained, to define one or more proposals for the user input and/or for a further user input, which for example makes the first user input more precise or is an alternative to the first user input. By way of example, an expedient proposal and/or proposals adapted to the user, driving situation, state of the user, etc., in particular for the selection of user inputs, can be provided, in particular generated, for the user as early as in the initial phase or during the procedure. The user can select from these in particular by means of a simplified operating action and/or the user can modify same further.

By means of the output, the generative pretrained transformer can furthermore make proposals to the user as to how the user input can be expediently supplemented. On the basis of such proposals, the user can decide significantly more easily how the user would like to define their user-specific functionality. Producing the output in order to assist the user in producing the user input thus increases the user-friendliness of the method.

In a further exemplary embodiment, the generative pretrained transformer is configured to define one or more proposals for the user input and/or for a further user input, which for example makes the first user input more precise or is an alternative to the first user input. By way of example, expedient proposals and/or proposals adapted to the user, the driving situation, the state of the user, in particular for the selection of user inputs, can be provided, in particular generated, for the user as early as in the initial phase or during the procedure. The user can select from these in particular by means of a simplified operating action and/or the user can modify same further.

In a further embodiment, depending on the input data and using the generative pretrained transformer, there is a determination of whether and which data, databases, libraries, interfaces, and/or drivers are required for providing the user-specific functionality. The program code is produced taking account of the result of the determination. The determination can be effected in particular using the generative pretrained transformer. Specific dependences may also have been characterized, in particular defined, in advance. By way of example, a specific driver may be required for actuating an already existing vehicle functionality or a functional unit of the vehicle. The corresponding information or the driver itself can be determined or generated by means of the generative pretrained transformer. The information can be taken into account or embedded or included in the process of producing the program code. Using the already existing elements mentioned above significantly simplifies the production of the program code and thus of the user-specific functionality. The user can be linked into the use of the already existing elements. By way of example, a specific library can be used only if the user has granted their express consent for this or has not opposed this. In particular, the user can be informed beforehand about the consequences of linking in the already existing elements and/or generating new elements.

In a further embodiment, the program code is produced in such a way that the computer program's access to resources of the control unit is limited when the computer program is executed on the control unit, in particular in such a way that the computer program has access only to predefined resources of the control unit. By way of example, the program code can be produced in such a way that the computer program has access only to demarcated CPU resources, RAM and/or onboard electrical system communication. This limitation can take place dynamically or be defined in advance. Limiting the resources of the control unit to which the computer program has access makes the execution of the computer program safer. The safety and/or availability can thus be increased in such a way as to conform to the standards and requirements typical of application in the automotive sector, in particular.

In a further embodiment, the program code is produced in such a way that the computer program's access to predefined vehicle functionalities is limited when the computer program is executed on the control unit. In this embodiment, the user-specific functionality can only concern such already existing vehicle functionalities which have been expressly enabled. This limitation makes the execution of the user-specific functionality considerably safer, such that the latter conforms to the standards and requirements typical of application in the automotive sector, in particular.

In a further embodiment, the control unit comprises an at least partly isolated runtime environment, in particular a hypervisor, a virtual machine or a trusted computing base. The program code is executed within the at least partly isolated runtime environment in order to provide the user-specific functionality. The at least partly isolated runtime environments limit computer programs' access to system resources, for example by virtualization. In this embodiment, one at least partly isolated runtime environment is used to limit the computer program's access to predefined resources of the control unit and/or predefined vehicle functionalities. This has the above-described advantages regarding safety and availability, in particular in the case of use in the automotive sector.

In a further embodiment, the program code is produced in such a way that results of the execution of the user-specific functionality which correspond to specific first features, in particular first value ranges and/or first patterns, are prohibited and/or that exclusively results of the execution of the user-specific functionality which correspond to specific second features, in particular second value ranges and/or second patterns, are enabled when the computer program is executed on the control unit. In this embodiment, the program code is produced in such a way that for example specific outputs or actions are restricted or entirely prohibited or that only predetermined outputs or actions are permitted. Specific image outputs and/or sound outputs can be prohibited, for example, in order to prohibit immoral outputs, for example. By way of example, the production of data links, characterized for example by the user, and the data aggregation can be prohibited or permitted only to a limited extent, characterized for example by the user. This can be done in order that applicable and/or user-desired data protection stipulations can be complied with better or user-specifically. Furthermore, specific actions of actuators of the vehicle can be forbidden or limited to a predefined scope in order to be able to ensure driving safety of the vehicle when the user-specific functionality is executed. The restrictions of the outputs and/or actions can be predetermined in particular person-specifically, vehicle-specifically, context-specifically and/or situation-specifically.

The invention furthermore relates to a device for producing a user-specific functionality of a vehicle. The device comprises an input unit configured to detect a user input which characterizes the user-specific functionality, and to produce input data depending on the user input. The device furthermore comprises a program generating unit configured, depending on the input data, to generate at least one part of a program code of a computer program which provides the user-specific functionality when the computer program is executed on a control unit of the vehicle.

The device has the same advantages as the claimed method. In particular, the device can be developed with the features of the dependent claims directed to the method. Furthermore, the above-described method can be developed with features which are described in connection with the device in this document.

In one embodiment, the input unit is configured to receive the user input in text form, in the form of a voice input and/or in the form of a user interaction with a graphical user interface. By way of example, the input unit can be configured to produce the graphical user interface in such a way that the latter has a series of elements from which the user can establish the user input. In this case, individual elements of the graphical user interface can correspond to parts of the user input, for example triggers and already existing vehicle functionalities. As a result, the user-friendliness of the device can be significantly improved further.

The invention furthermore relates to a computer program product for producing a user-specific functionality. The computer program product comprises a computer program for producing the user-specific functionality, which computer program is configured to execute the above-described method when the computer program for producing the user-specific functionality is executed on one or more control units.

The computer program product has the same advantages as the claimed method and the claimed device. In particular, the computer program product can be developed with the features of the dependent claims directed to the method or the devices. Furthermore, the above-described method and the above-described device can be developed with features which are described in connection with the computer program product in this document.

In accordance with one embodiment, the computer program comprises at least one part of a generative pretrained transformer which is pretrained and designed for example for executing the method, in particular a part of the respective pretrained model, and/or logic and/or data for training, in particular retraining, and/or for operating the generative pretrained transformer. The at least one part, for example part of the model, specific layers of the neural network, etc., of the pretrained generative pretrained transformer can be configured for executing one or more steps of the method or can be configured as an update of a previous computer program, which are installed or updated on the respective units of the vehicle for example in the context of a functional extension, for example in the context of a so-called “remote software update”, in particular by means of a data connection.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of a device for producing a user-specific

functionality of a vehicle; and

FIG. 2 is a flowchart of a method for producing the user-specific functionality of the vehicle.

### DETAILED DESCRIPTION OF THE DRAWINGS

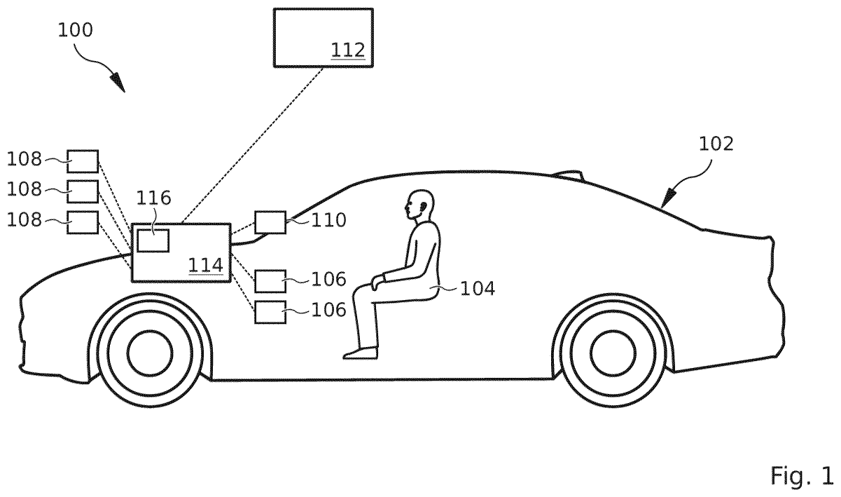

FIG. 1 shows a schematic illustration of a device 100 for producing a user-specific functionality of a vehicle 102.

The device 100 serves to enable a user 104 to produce the user-specific functionality for the vehicle 102 in a simple manner. The user-specific functionality consists in particular in executing one or more vehicle functionalities 106 already existing, i.e. for example already present or belonging to the scope of supply of the vehicle 102, in a manner predefined by the user. The vehicle functionalities 106 are illustrated purely by way of example as functional units of the vehicle 102 in FIG. 1. In particular, the user 104 can characterize, in particular define or specify, that the user-specific functionality is executed depending on specific sensor data or sensor data representing specific conditions, which sensor data are provided by sensors 108 of the vehicle 102, or depending on variables derived from sensor data, for example the instantaneous driving situation or a state of the user 104. In one example, the user 104 defines the user-specific functionality in a form in which, in poor weather, for example when poor weather is forecast and/or recognized and/or when information about poor weather is determined, a warning about pedestrians ought to be output earlier than otherwise and/or in a different way. In this example, the sensor data comprise weather data and for example are determined by an exterior camera and/or received from a corresponding service. In this example, the warning about pedestrians is actuated as already existing vehicle functionality.

The device 100 comprises an input unit 110 for receiving a user input of the user 104 and for converting the user input into input data. The user input defines the user-specific functionality and can be effected in particular in natural language, in particular in combination with one or more further inputs. In one particularly simple embodiment, the input unit 110 is configured to receive the user input in text form. By way of example, the input unit 110 comprises a keyboard or a touchscreen with a corresponding input function. However, the input unit 110 can also comprise a microphone for receiving the user input in linguistic or spoken form. In such an embodiment, the input unit 110 is configured in particular to carry out a voice recognition method in order to convert the spoken user input into input data in a text form, which are thus able more easily to be processed further.

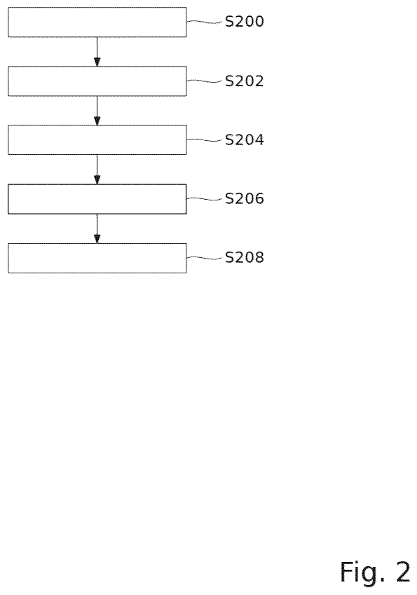

Alternatively or additionally, the input unit 110 can furthermore be configured to output a graphical user interface to the user 104 and to receive the user input as a user interaction with the graphical user interface. By way of example, the input unit 110 is a touchscreen of the vehicle 102 and the user interaction consists in elements of the graphical user interface which correspond in each case to sensor inputs and already existing vehicle functionalities 106, for example, being combined in a linking manner in order to form the user input. The user input is described in even greater detail below with reference to FIG. 2.

The device 100 furthermore comprises a program generating unit 112 configured to generate, from the user input, at least one part of a program code of a computer program which provides the user-specific functionality when the computer program is executed on a control unit 114 of the vehicle 102. The program generating unit 112 can be a part of the vehicle 102 itself. FIG. 1 shows the program generating unit 112 purely by way of example as a computing unit remote from the vehicle 102, for example a backend server or a cloud server. Furthermore, the program generating unit 112 can also be distributed between a computing unit of the vehicle 102 and the computing unit remote from the vehicle 102. By way of example, specific functions of the program generating unit 112 are executed locally in the vehicle 102, while other, in particular computationally intensive functions of the program generating unit 112 are executed on the remote computing unit.

The program generating unit 112 is configured in particular to operate a generative pretrained transformer in order to produce the program code. In this case, the input data are input to the generative pretrained transformer as input and the output of the generative pretrained transformer corresponds to at least one part of the program code.

Preferably, the generative pretrained transformer described in the present document is a comparatively weak and/or comparatively narrowly specialized artificial intelligence. As a result, the method is realizable significantly more simply and/or with limited resources, for example using the means of the vehicle 102, and/or is better manageable in terms of practical handling. By way of example, as a result, possible risks during use, for example of a relatively universal or strong artificial intelligence, can be reduced and/or the result of the method can be made better predictable.

The generative pretrained transformer can alternatively or additionally be operated in order to assist the user 104 in formulating the user input. By way of example, the generative pretrained transformer can be operated in order to produce a list with proposals for the user input or proposals for the completion of the user input. These proposals can be generated depending on: driving situation data identifying a driving situation concerning the vehicle; occupant state data identifying the state of a vehicle occupant; and/or vehicle state data identifying the state of the vehicle, in particular of one or more devices or vehicle functions, in order to produce data. The aforementioned data can be based for example on the sensor data and vehicle functionalities 106 available in the vehicle 102, but also on a state—detected for example by a user device, for instance: smartphone, smartwatch, smart clothes—of the user 104 or the vehicle 102, for example the driving situation.

In the context of the present document, the term “driving situation” can be understood for example as a specific situation identified by an arrangement, action or interaction of road users or by specific driving parameters of road users, in particular at the consideration level of specific objects. In particular, the meaning of the term “driving situation” therefore differs from an often colloquially used meaning of the term “traffic situation”, which corresponds rather to the summarizing, general and/or statistical categories such as, for instance, “free traffic”, “heavy traffic”, “slow-moving traffic”, “congestion”, “end of the backup”, etc. However, the driving situation or the driving situation data described in the present document can also or only characterize the respective traffic situation or comprise or be traffic situation data.

The term driving situation can furthermore be interpreted as parameters of the driving situation. One or more parameters of the driving situation can identify, in particular represent, a specific pattern, in particular a data pattern, for example a pattern identifying an arrangement and/or speed of objects and/or a pattern of the parameters of the driving situation. Moreover, the driving situation can be identified by a spatial pattern of the so-called free spaces in the surroundings of the vehicle or by corresponding parameters. Preferably, the driving situation can be identified by one or more of the features enumerated below or parameters of the driving situation that correspond to these features:
a specific spatial distribution of the road users and/or of the movement parameters of the road users, in particular an arrangement pattern of the road users in the surroundings of the vehicle;
a specific spatial distribution of immobile objects in the surroundings of the vehicle;
a relative position and/or movement parameters of specific kinds of lane markings, traffic signs and/or light signal systems;
information about the right of way of the vehicle, in particular vis-à-vis specific road users and/or road users that come or may come actually or at least potentially from specific directions, for example from a crossing road from the right or from the left;
information concerning an action—for example exceeding a limit value—of a road user in the surroundings of the vehicle, such as for example sounding the horn, headlight flashing, tailgating, overtaking of the vehicle, an attempt at overtaking, and the like.

Furthermore, the driving situation can be identified by one or more parameters in connection with relevant traffic rules, traffic signs, rights of way, traffic lights and/or traffic light phases. The driving situation or driving situation data described in the present document can identify, characterize or represent any combination of the features described.

As one or more parameters of the driving situation, a temporal and/or spatial change characteristic, in particular a gradient, for instance a temporal and/or spatial gradient of the respective parameter, in particular parameter value, of the driving situation or of the traffic situation can also be taken into account.

By way of example, driving situation parameters based on environment sensor data and/or information communicated to the vehicle can also be taken into account, for example information communicated from a further road user, by means of Car-2-Car or Car-2-X. In this case, the environment sensor data can be data-processed in a specific way—of an environment—detecting sensor in particular of a sensor system of at least one vehicle. Alternatively or additionally, traffic rule information indicative of one or more traffic rules can be determined and taken into account in the method. The traffic rule information can correspond to the legal regulations and/or logic, for example. The traffic rules can be specific for example to the whereabouts, in particular country, province, location of the vehicle.

The state of the vehicle is understood to mean for example one or more odometric parameters, for example movement parameters such as the instantaneous speed or the instantaneous longitudinal and transverse acceleration of the vehicle or a chassis parameter. However, further information can also be regarded as the state of the vehicle, for example a fill level or state of charge of one or more energy stores of the vehicle or chassis parameters. Furthermore, the operating state, in particular operating mode or a current driving mode of the vehicle can be determined and taken into account.

In order to enable a particularly well predictable and/or particularly safe execution of the user-specific functionality and/or to fulfil the high and/or specific requirements in respect of safety and availability in the automotive sector, which are selectable in particular by the user, the program generating unit 112 can be configured to produce the program code such that the corresponding computer program has only limited access to specific resources. By way of example, the access by the computer program which is produced in the method and which corresponds to the program code can be limited to specific system resources of the control unit 114, for example CPU and RAM. Furthermore, the access can be restricted to specific already existing vehicle functionalities 106, in particular to those which are not safety-critical. Moreover, the program generating unit 112 can be configured to produce the program code such that either specific outputs produced by the computer program or effected actions are prohibited or limited. Alternatively or additionally, it is also possible for only predetermined outputs or actions to be allowed. By way of example, all actions which are related to actuators of the vehicle 102, i.e. for example indirectly or directly control one or more, in particular safety-relevant, actuators, or an execution of the user-specific functionality can be limited in such a way that the driving safety of the vehicle 102 is not endangered when the user-specific functionality is executed.

The program generating unit 112 can furthermore be configured to determine whether and which further program elements or data are required for providing the user-specific functionality, and to produce the program code taking account of the result of this determination. Program elements here can be for example libraries, interfaces, and/or drivers. Data can be for example databases or data connections which are required for providing the user-specific functionality. The determination can likewise be effected using the generative pretrained transformer.

The control unit 114 of the vehicle 102 is configured as a computing unit of the vehicle 102 in the exemplary embodiment shown. Alternatively, the control unit 114 can also be at least partly formed by a computing unit remote from the vehicle 102. In the exemplary embodiment shown, the control unit 114 comprises an at least partly isolated runtime environment 116, for example a hypervisor, a virtual machine or a trusted computing base. Within this runtime environment 116, it is possible to execute computer programs with limited access to resources of the control unit 114. This allows simple limitation of the resources of the control unit 114 to which the computer program produced by the program generating unit 112 has access, in order to enable safe execution of the user-specific functionality.

FIG. 2 shows a flowchart of a method for producing the user-specific functionality of the vehicle 102.

The method is started in step S200. In step S202, the input unit 110 receives the user input from the user 104. By means of the user input, the user 104 characterizes the desired user-specific functionality by virtue of the user 104 defining for example the mode of operation of the user-specific functionality.

In order to characterize the user-specific functionality, the user 104 can determine and/or define for example one or more inputs of the user-specific functionality, for example features described in the form of adjectives, nouns and verbs. The user 104 can determine or define the input for example by making reference or referring to any current detected surroundings and/or driving situation. Further possible inputs are the position of the vehicle 102, for example a specific roadway location, one or more specific events or events identified by specific features, for example driving situations, a geographical position and/or a position on a map. By way of example, the position can be described by an, optionally abstract, user input which is described by a specific relationship, by a logic, and/or comprises a collective term. By way of example as the nearest free and/or no-charge or reasonable parking lot having a specific feature, for example a filling station, a charging point, a workshop or an ice cream parlor.

The position on the map can be determined or defined for example by a selection on a map. A map is understood here to be in particular a digital map, a layer of the map and/or digitized surroundings, in particular an image representation of the surroundings. In order to further characterize the user-specific functionality, the user 104 can additionally predefine one or more functional links, in particular logical links. By way of example, the user 104 can link together an event, a recognizable pattern, a specific parameter value and/or a recording of surroundings or a situation. The link can furthermore be made dependent on a specific input.

The functioning of the user-specific functionality can be characterized by the user 104 in their user input by virtue of the fact that for example a specific action is intended to be executed or an action that is executed anyway is intended to be adapted. For example, the execution of a vehicle functionality or action otherwise due, for example under specific conditions, for example in the case of user-definable conditions, can be deactivated, paused, suspended and/or changed in some other definable way. Furthermore, for example, it is possible to determine specific information from a database and/or the Internet, an information display can be produced and/or a voice message can be generated. Moreover, the user 104 can enable for the user-specific functionality access to specific functions, for example to input interfaces of the vehicle 102 and/or of a computing unit remote from the vehicle 102, specific vehicle functionalities 106, output interfaces of the vehicle 102 and/or of the computing unit remote from the vehicle 102, the Internet, chatbots, and/or digital agents, in particular personified agents of the user 104.

Furthermore, the user 104, by means of the user input, can define a user-specific functionality which instigates the control of one or more specific, for example selectable, vehicle functionalities 106, for example of definable conditions, cases and/or in a definable manner. These can be various user-specific vehicle functionalities 106 already present or already produced. By way of example, this can involve one or more multimedia functionalities and/or infotainment functionalities, i.e. the functionality of a multimedia system, of an infotainment system, or a functionality supplementing same, a navigation functionality, i.e. a functionality of a navigation system or a functionality supplementing same, a climate control functionality, i.e. a functionality of an air-conditioning system or a functionality supplementing same, a functionality for adjusting or setting one or more interior elements, in particular seats, and/or a personalization system.

In summary, in the user input the user 104 defines a series of characterizing features of the user-specific functionality. In particular input variables, in particular a concrete selection of variables and/or incidents which are intended to be taken into account, references to specific geographical positions or objects, the desired effect of the functionality, a mode of operation and/or operative logic, applications which are intended to be influenced by the user-specific functionality, and/or restrictions, for example concerning one or more conditions mentioned above. Exemplary user inputs are: “When we're getting close to our house and the boy from next door is running around behind our apple tree, then sound the horn loud if only Peter is traveling in the vehicle 102 or reduce speed if Sabine is traveling or also traveling in the vehicle 102”. “The next time we drive past a shoe shop or toyshop, distracting content should be played for Sabine or little Kathy”. “When the weather is bad, please issue the warnings about pedestrians a little earlier”. Other inputs are possible; by way of example, the user in the last-mentioned example can also characterize a different output form than the one used previously. The method enables the user to produce individual functionality which is tailored to the user's requirements and/or the user-typical use of the vehicle and/or is adapted for the user's specific vehicle. It is thus possible to comply with even a particularly pronounced requirement for individualization, in particular for premium vehicles or corresponding customer segments.

In step S204, depending on the user input, the program generating unit 112 then produces at least one part of the program code of the computer program which provides the user-specific functionality when the computer program is executed on the control unit 114 of the vehicle 102. The program code can be produced in such a way that the user-specific functionality is optimized for example for a specific user 104, in particular a vehicle driver, a specific use style, in particular driving style, and/or a specific driving situation. Alternatively or additionally, the program code can be produced in such a way that the user-specific functionality is optimized for a specific roadway section or roadway section corresponding to one or more specific features, in particular patterns. By way of example an arrangement of roadways, lanes, traffic signs and/or applicable traffic rules which correspond to specific features or criteria. By way of example, this can involve an intersection, an entrance, an exit, a traffic circle, etc., which correspond to specific criteria, for example patterns, independently of their concrete geographical position. Alternatively or additionally, however, the roadway section can also be characterized by its geographical position.

Alternatively or additionally, the program code can be implemented in relation to a position on a digital map, in digitized surroundings, and/or a position which was determined on the basis of sensor data. In this case, the user-specific functionality can be assigned to a position, a section of a map and/or a pattern of digitized surroundings, in particular detected by sensor. This can be done in such a way that the user-specific functionality reacts in the desired way to the vehicle traversing, for example repeatedly, the position. In one example, the program code is produced such that the user-specific functionality assists a vehicle driver in entering or exiting from a particular or specific exit, i.e. specific to the user or their routes, a garage and/or grounds.

After the program generating unit 112 has produced the program code, the latter is converted into the computer program, if necessary. The conversion can be effected by compiling, in particular also by just-in-time compilation. In particular, the computer program is produced in such a way that it is executable in the at least partly isolated runtime environment 116. In step S206, the computer program is then provided on the control unit 114 of the vehicle 102. The user-specific functionality is then executed by way of the execution of the computer program on the control unit 114 of the vehicle 102. The method is then ended in step S208.

In the exemplary embodiment described with reference to FIGS. 1 and 2, at least the input unit 110 and the control unit 114 form the device 100 for producing the user-specific functionality of the vehicle 102. Further elements and features shown in FIGS. 1 and 2 and mentioned in the preceding description can be part of the claimed device 100. Likewise, method steps described on the basis of the device 100 can be part of the claimed method.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

100 Device
102 Vehicle
104 User
106 Functional unit
108 Sensor
110 Input unit
112 Program generating unit
114 Control unit
116 Runtime environment

What is claimed is:

1. A method for producing a user-specific functionality of a vehicle, the method comprising:
detecting a user input which characterizes the user-specific functionality, and producing input data depending on the user input;
depending on the input data, generating at least one part of a program code of a computer program, which computer program provides the user-specific functionality when the computer program is executed on a control unit of the vehicle; and
providing the computer program for execution on the control unit of the vehicle in order to provide the user-specific functionality.

2. The method according to claim 1, wherein the program code is produced using a generative pretrained transformer.

3. The method according to claim 2, wherein
taking account of at least one driving situation, a state of a vehicle occupant, and/or a state of the vehicle, and using the generative pretrained transformer, producing an output in order to assist the user in producing the user input.

4. The method according to claim 2, wherein
depending on the input data and using the generative pretrained transformer, determining whether and which data, databases, libraries, interfaces, and/or drivers are required for providing the user-specific functionality, and
producing the program code taking account of the result of the determining.

5. The method according to claim 1, wherein
the program code is produced such that the computer program's access to resources of the control unit is limited when the computer program is executed on the control unit.

6. The method according to claim 5, wherein
the program code is produced such that the computer program has access only to predefined resources of the control unit.

7. The method according to claim 1, wherein
the program code is produced such that the computer program's access to predefined vehicle functionalities is limited when the computer program is executed on the control unit.

8. The method according to claim 1, wherein
the control unit comprises an at least partly isolated runtime environment, and the program code is executed within the at least partly isolated runtime environment in order to provide the user-specific functionality.

9. The method according to claim 8, wherein the control unit comprising the at least partly isolated runtime environment is a hypervisor, a virtual machine or a trusted computing base.

10. The method according to claim 1, wherein the program code is produced such that:
results of the execution of the user-specific functionality which correspond to specific first features are prohibited, and/or
exclusively results of the execution of the user-specific functionality which correspond to specific second features are enabled when the computer program is executed on the control unit.

11. The method according to claim 10, wherein the specific first features are first value ranges and/or first patterns, and/or the specific second features are second value ranges and/or second patterns.

12. A device for producing a user-specific functionality of a vehicle, comprising:
an input unit configured to detect a user input which characterizes the user-specific functionality, and to produce input data depending on the user input; and
a program generating unit configured, depending on the input data, to generate at least one part of a program code of a computer program which provides the user-specific functionality when the computer program is executed on a control unit of the vehicle.

13. The device according to claim 12, wherein
the input unit is configured to receive the user input in text form, in the form of a voice input, and/or in the form of a user interaction with a graphical user interface.

14. A computer product comprising a non-transitory computer readable medium having stored thereon program code which, when executed, produces a user-specific functionality, by:
detecting a user input which characterizes the user-specific functionality, and producing input data depending on the user input;
depending on the input data, generating at least one part of a program code of a computer program, which computer program provides the user-specific functionality when the computer program is executed on a control unit of the vehicle; and
providing the computer program for execution on the control unit of the vehicle in order to provide the user-specific functionality.

15. The computer product according to claim 14, wherein the program code comprises at least one part of a generative pretrained transformer.
